(19) United States
(12) Patent Application Publication
(10) Pub. No.: US 2015/0369342 A1
(43) Pub. Date: Dec. 24, 2015

(54) AUTOMATIC TRANSMISSION

(71) Applicants: AISIN AW CO., LTD., Anjo-shi, Aichi (JP); TOYOTA JIDOSHA KABUSHIKI KAISHA, Toyota-shi, Aichi (JP)

(72) Inventors: Takayoshi KATO, Handa (JP); Toshihiko AOKI, Anjo (JP); Hiroshi KATO, Kariya (JP); Nobutada SUGIURA, Nishio (JP); Takashi MORIMOTO, Gamagori (JP); Nobukazu IKE, Kariya (JP); Satoru KASUYA, Nishio (JP); Terufumi MIYAZAKI, Toyota (JP); Masaru MORISE, Nukata (JP); Shinji OITA, Toyota (JP)

(21) Appl. No.: 14/766,407

(22) PCT Filed: Mar. 27, 2014
(86) PCT No.: PCT/JP2014/058744

§ 371 Date: Aug. 6, 2015

(30) Foreign Application Priority Data
Mar. 28, 2013 (JP) 2013-070470

(51) Int. Cl. F16H 3/66

(52) U.S. Cl. CPC F16H 3/66; F16H 2200/0078; F16H 2200/2012; F16H 2200/2046

(57) ABSTRACT

An automatic transmission that shifts power applied to an input member and outputs the shifted power to an output member, the automatic transmission including a first planetary gear mechanism, a second planetary gear mechanism, a third planetary gear mechanism, a fourth planetary gear mechanism, a first coupling element, a second coupling element, a third coupling element, a fourth coupling element, a first clutch, a second clutch, a third clutch, a fourth clutch, a first brake and a second brake.

### BACKGROUND

This technique relates to automatic transmissions that shift power applied to an input member and output the shifted power to an output member.

In recent years, in order to improve fuel economy and acceleration performance of vehicles, multi-speed automatic transmissions have been developed as stepped automatic transmissions that are mounted on the vehicles. An automatic transmission that attains twelve forward speeds and a reverse speed by using four planetary gear mechanisms and six engagement elements comprised of three clutches and three brakes is conventionally proposed as such a stepped automatic transmission (see US 2010/0144486).

### SUMMARY

In general, the larger the number of shift speeds is, the wider the ratio spread (speed ratio range; hereinafter simply referred to as the “spread”) of such automatic transmissions is, making it possible to shift to an optimal gear speed.

Planetary gear mechanisms include single-pinion type planetary gear mechanisms and double-pinion type planetary gear mechanisms. As compared to the double-pinion type planetary gear mechanisms in which two pinion gears are arranged next to each other in the radial direction, the single-pinion type planetary gear mechanisms have a simpler structure and smaller meshing loss as the pinion gears do not mesh with each other. It is therefore desired to use as many single-pinion type planetary gear mechanisms as possible to form an automatic transmission.

Moreover, drag loss is caused even when the engagement elements are in a disengaged state. It is therefore desired to reduce as much as possible the number of engagement elements to be disengaged at each shift speed. It is also desired that those engagement elements which cause great drag loss be engaged at a shift speed that is frequently used.

In US 2010/0144486, a twelve forward speed automatic transmission is formed by using four planetary gear mechanisms and six engagement elements. However, the automatic transmission can be designed in countless ways by using the four planetary gear mechanisms and the six engagement elements, and it is very difficult to find an automatic transmission having as many functions as possible which are desirable for such an automatic transmission as described above.

The present disclosure according to an exemplary aspect provides a new automatic transmission capable of attaining twelve forward speeds and one reverse speed by using four planetary gear mechanisms and six engagement elements.

According to an exemplary aspect of the presents disclosure, an automatic transmission shifts power applied to an input member and outputs the shifted power to an output member, the automatic transmission including: a first planetary gear mechanism having a first rotary element, a second rotary element, and a third rotary element in order of an interval corresponding to a gear ratio in a speed diagram; a second planetary gear mechanism having a fourth rotary element, a fifth rotary element, and a sixth rotary element in order of an interval corresponding to a gear ratio in a speed diagram; a third planetary gear mechanism having a seventh rotary element, an eighth rotary element, and a ninth rotary element in order of an interval corresponding to a gear ratio in a speed diagram; a fourth planetary gear mechanism having a tenth rotary element, an eleventh rotary element, and a twelfth rotary element in order of an interval corresponding to a gear ratio in a speed diagram; a first coupling element that couples the first rotary element to the fourth rotary element; a second coupling element that couples the third rotary element to the eleventh rotary element; a third coupling element that couples the fifth rotary element to the ninth rotary element; a fourth coupling element that couples the seventh rotary element to the tenth rotary element; a first clutch capable of engaging two of the tenth rotary element, the eleventh rotary element, and the twelfth rotary element with each other and disengaging the two of the tenth rotary element, the eleventh rotary element, and the twelfth rotary element from each other; a second clutch capable of engaging the second rotary element with the eighth rotary element and disengaging the second rotary element from the eighth rotary element; a third clutch capable of engaging the sixth rotary element with the eighth rotary element and disengaging the sixth rotary element from the eighth rotary element; a fourth clutch capable of engaging the sixth rotary element with the fourth coupling element and disengaging the sixth rotary element from the fourth coupling element; a first brake that engages the first coupling element with an automatic transmission case so that the first coupling element can be held stationary with respect to the automatic transmission case, and that disengages the first coupling element from the automatic transmission case; and a second brake that engages the twelfth rotary element with the automatic transmission case so that the twelfth rotary element can be held stationary with respect to the automatic transmission case, and that disengages the twelfth rotary element from the automatic transmission case, wherein the input member is coupled to the fifth rotary element, and the output member is coupled to the second rotary element.

Configuring the automatic transmission in this manner allows twelve forward speeds and one reverse speed to be attained by using the four planetary gear mechanisms, the four clutches, and the two brakes. This can increase the gear spread from the lowest shift speed to the highest shift speed, and can improve acceleration performance and fuel economy performance of vehicles.

Each shift speed is attained by engaging three of the six engagement elements and disengaging the remaining three engagement elements. Accordingly, the number of engagement elements to be disengaged to attain a shift speed is relatively small, which can reduce drag loss that is caused by the disengaged engagement elements, and can improve transmission efficiency of the automatic transmission.

Moreover, in the above automatic transmission, the four planetary gear mechanisms can be, e.g., single-pinion type planetary gear mechanisms. The use of the single-pinion type planetary gear mechanisms can reduce gear meshing loss and can thus improve the transmission efficiency of the automatic transmission. The use of the single-pinion type planetary gear mechanisms can also reduce the number of components and can thus reduce assembly time and cost of the automatic transmission.

### BRIEF DESCRIPTION OF THE DRAWINGS

FIG. 1 is a skeleton diagram showing an automatic transmission according to a first embodiment.

FIG. 2 is an engagement table of the automatic transmission according to the first embodiment.

FIG. 3 is a speed diagram of the automatic transmission according to the first embodiment.

FIG. 4 is a skeleton diagram showing an automatic transmission according to a second embodiment.

FIG. 5 is a skeleton diagram showing an automatic transmission according to a third embodiment.

### DETAILED DESCRIPTION OF THE EMBODIMENTS

### First Embodiment

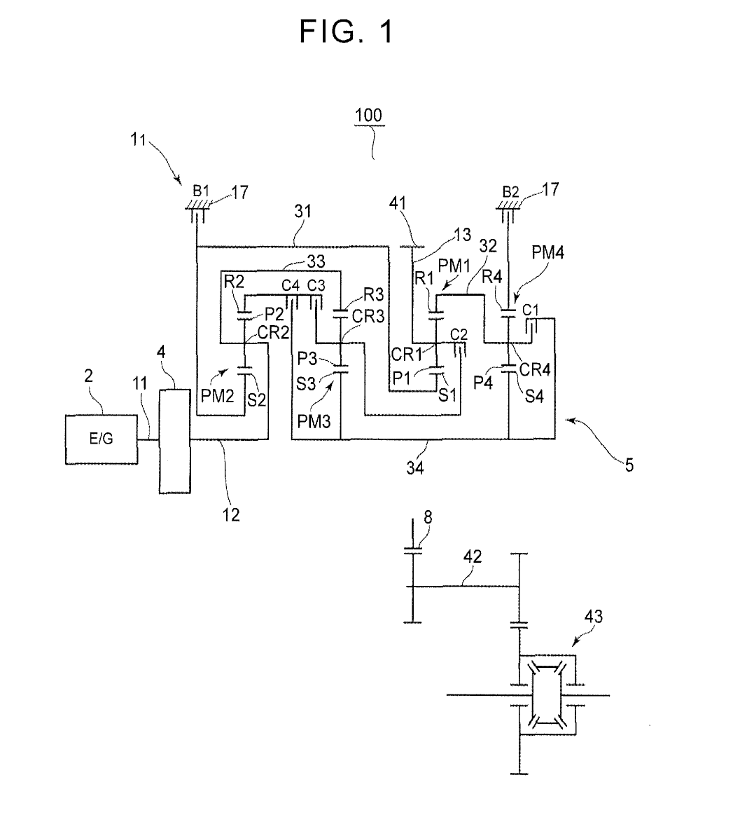

An automatic transmission 1₁ according to a first embodiment will be described below with reference to FIGS. 1 to 3. First, the general configuration of the automatic transmission 1₁ will be described with reference to FIG. 1. As shown in FIG. 1, the automatic transmission 1₁ that is preferably used in, e.g., a front engine, front drive (FF) vehicle 100 has an input shaft 11 of the automatic transmission 1₁ which can be connected to an internal combustion engine (drive source) 2. The automatic transmission 1₁ includes about the axial direction of the input shaft 11 a starting device 4 such as a torque converter and a speed change mechanism 5.

The speed change mechanism 5 is a stepped speed change mechanism that includes four single-pinion type planetary gear mechanisms PM1 to PM4, four clutches C1, C2, C3, C4, and two brakes B1, B2, and that receives power from the internal combustion engine 2 via an input shaft (input member) 12 drivingly coupled to the starting device 4 and shifts the received power to output the shifted power from an output shaft 13 as an output member between the first planetary gear mechanism PM1 and the third planetary gear mechanism PM3 and a counter gear 41. The power output from the output shaft (output member) 13 is transmitted to a countershaft 42 via the counter gear 41, and the power output to the countershaft 42 is transmitted to driving wheels via a differential unit 43.

As shown in FIG. 1, the above planetary gear mechanisms PM1 to PM4 are arranged on the input shaft 12 in order of the second planetary gear mechanism PM2, the third planetary gear mechanism PM3, the first planetary gear mechanism PM1, and the fourth planetary gear mechanism PM4 from left to right in the figure, namely from the front to the rear of the vehicle. The first planetary gear mechanism PM1 is a single-pinion type planetary gear mechanism, which includes a first sun gear S1 (first rotary element), a first carrier CR1 (second rotary element), and a first ring gear R1 (third rotary element), and in which a plurality of pinion gears P1 each meshing with the first sun gear S1 and the first ring gear R1 are arranged in the circumferential direction, and the first carrier CR1 holds the pinion gears P1 so that the pinion gears P1 can rotate and revolve.

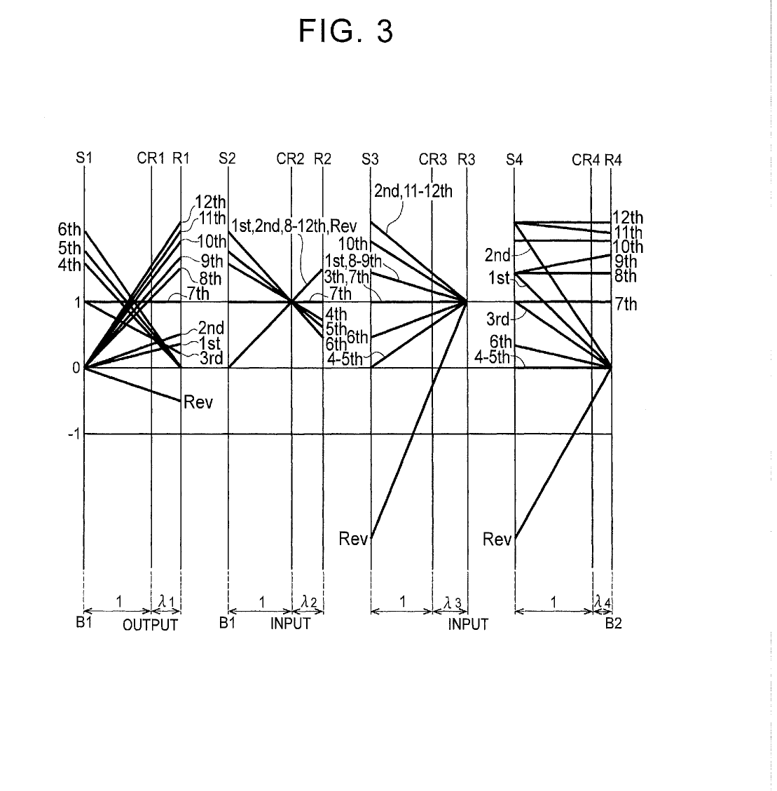

Since the first planetary gear mechanism PM1 is of a single-pinion type, the three rotary elements, namely the first sun gear S1, the first ring gear R1, and the first carrier CR1, are shown in order of the first sun gear S1, the first carrier CR1, and the first ring gear R1 according to the interval corresponding to the gear ratio in a speed diagram (see FIG. 3). The gear ratio λ₁ of the first planetary gear mechanism PM1 (the number of teeth of the first sun gear S1/the number of teeth of the first ring gear R1) is set to, e.g., 0.45.

Like the first planetary gear mechanism PM1, the second planetary gear mechanism PM2 is also configured as a single-pinion type planetary gear mechanism, and includes as three rotary elements a second sun gear S2 (fourth rotary element), a second ring gear R2 (sixth rotary element), and a second carrier CR2 (fifth rotary element) that couples a plurality of pinion gears P2 and holds the pinion gears P2 so that the pinion gears P2 can rotate and revolve. The three rotary elements of the second planetary gear mechanism PM2, namely the second sun gear S2, the second ring gear R2, and the second carrier CR2, are shown in order of the second sun gear S2, the second carrier CR2, and the second ring gear R2 according to the interval corresponding to the gear ratio in the speed diagram. The gear ratio λ₂ of the second planetary gear mechanism PM2 (the number of teeth of the second sun gear S2/the number of teeth of the second ring gear R2) is set to, e.g., 0.55.

Like the first and second planetary gear mechanisms PM1, PM2, the third planetary gear mechanism PM3 is also configured as a single-pinion type planetary gear mechanism, and includes as three rotary elements a third sun gear S3 (seventh rotary element), a third ring gear R3 (ninth rotary element), and a third carrier CR3 (eighth rotary element) that couples a plurality of pinion gears P3 and holds the pinion gears P3 so that the pinion gears P3 can rotate and revolve. The three rotary elements of the third planetary gear mechanism PM3, namely the third sun gear S3, the third ring gear R3, and the third carrier CR3, are shown in order of the third sun gear S3, the third carrier CR3, and the third ring gear R3 according to the interval corresponding to the gear ratio in the speed diagram. The gear ratio λ₃ of the third planetary gear mechanism PM3 (the number of teeth of the third sun gear S3/the number of teeth of the third ring gear R3) is set to, e.g., 0.65.

Like the first to third planetary gear mechanisms PM1 to PM3, the fourth planetary gear mechanism PM4 is also configured as a single-pinion type planetary gear mechanism, and includes as three rotary elements a fourth sun gear S4 (tenth rotary element), a fourth ring gear R4 (twelfth rotary element), and a fourth carrier CR4 (eleventh rotary element) that couples a plurality of pinion gears P4 and holds the pinion gears P4 so that the pinion gears P4 can rotate and revolve. The three rotary elements of the fourth planetary gear mechanism PM4, namely the fourth sun gear S4, the fourth ring gear R4, and the fourth carrier CR4, are shown in order of the fourth sun gear S4, the fourth carrier CR4, and the fourth ring gear R4 according to the interval corresponding to the gear ratio in the speed diagram. The gear ratio λ₄ of the fourth planetary gear mechanism PM4 (the number of teeth of the fourth sun gear S4/the number of teeth of the fourth ring gear R4) is set to, e.g., 0.25.

The second carrier CR2 is coupled to the input shaft 12 so as to receive rotation from the internal combustion engine 2, and the first sun gear S1 and the second sun gear S2 are coupled by a first coupling element 31. The first ring gear R1 and the fourth carrier CR4 are coupled by a second coupling element 32, and the second carrier CR2 and the third ring gear R3 are coupled by a third coupling element 33. Moreover, the third sun gear S3 and the fourth sun gear S4 are coupled by a fourth coupling element 34, and the first carrier CR1 is coupled to the output shaft 13.

In addition, the first clutch C1 can engage the fourth sun gear S4 with the fourth carrier CR4 and can disengage the fourth sun gear S4 from the fourth carrier CR4. That is, by engaging the first clutch C1, the fourth carrier CR4 is coupled to the fourth coupling element (i.e., the third sun gear S3 and the fourth sun gear S4) 34, so that the fourth sun gear S4 and the fourth carrier CR4 of the fourth planetary gear mechanism PM4 make the same rotation, and the fourth planetary gear mechanism PM4 is brought into an integrally rotating state, namely in the state where the fourth sun gear S4, the fourth carrier CR4, and the fourth ring gear R4 rotate together. The fourth carrier CR4 is decoupled from the fourth coupling element 34 (the fourth planetary gear mechanism PM4 is caused to be no longer in the integrally rotating state) by disengaging the first clutch C1.

The second clutch C2 can engage the first carrier CR1 with the third carrier CR3 and can disengage the first carrier CR1 from the third carrier CR3. That is, the first carrier CR1 and the third carrier CR3 are coupled to each other by engaging the second clutch C2, and are decoupled from each other by disengaging the second clutch C2.

The third clutch C3 can engage the second ring gear R2 with the third carrier CR3 and can disengage the second ring gear R2 from the third carrier CR3. That is, the second ring gear R2 and the third carrier CR3 are coupled to each other by engaging the third clutch C3, and are decoupled from each other by disengaging the third clutch C3.

The fourth clutch C4 can engage the fourth coupling element 34 (i.e., the third sun gear S3 and the fourth sun gear S4) with the second ring gear R2 and can disengage the fourth coupling element 34 from the second ring gear R2. That is, the fourth coupling element 34 and the second ring gear R2 are coupled to each other by engaging the fourth clutch C4, and are decoupled from each other by disengaging the fourth clutch C4.

The first brake B1 can engage the first coupling element (i.e., the first sun gear S1 and the second sun gear S2) 31 with an automatic transmission case 17 so that the first coupling element 31 can be held stationary with respect to the automatic transmission case 17, and can disengage the first coupling element 31 from the automatic transmission case 17. That is, the first coupling element 31 is held stationary with respect to the automatic transmission case 17 by engaging the first brake B1, and is allowed to rotate by disengaging the first brake B1.

The second brake B2 can engage the fourth ring gear R4 with the automatic transmission case 17 so that the fourth ring gear R4 can be held stationary with respect to the automatic transmission case 17, and can disengage the fourth ring gear R4 from the automatic transmission case 17. That is, the fourth ring gear R4 is held stationary with respect to the automatic transmission case 17 by engaging the second brake B2, and is allowed to rotate by disengaging the second brake B2.

The speed change mechanism 5 thus configured can switch among first to twelfth forward speeds and a reverse speed by combination of engagement and disengagement of the four clutches C1 to C4 and the two brakes B1, B2. Functions of the speed change mechanism 5 will be described below with reference to FIGS. 1 to 3.

In the speed diagram shown in FIG. 3, the ordinate represents the rotational speed of each rotary element (each gear), and the abscissa corresponds to the gear ratio of each rotary element. In FIG. 3, the speed diagram of the first planetary gear mechanism PM1, the speed diagram of the second planetary gear mechanism PM2, the speed diagram of the third planetary gear mechanism PM3, and the speed diagram of the fourth planetary gear mechanism PM4 are shown in this order from left to right, and the sun gear, the carrier, and the ring gear are shown in this order in the speed diagram of each planetary gear mechanism.

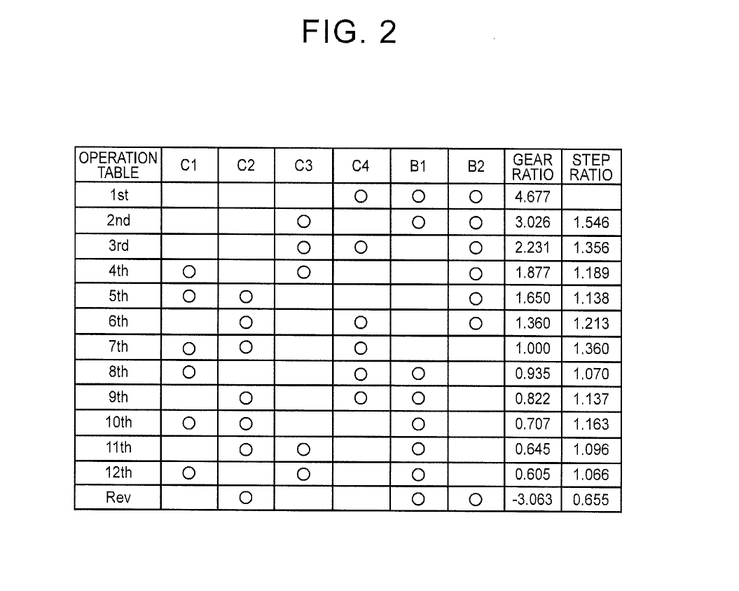

For example, at the first forward speed (1st) in a drive (D) range, as shown in FIG. 2, the fourth clutch C4 and the first and second brakes B1, B2 are engaged, and the first to third clutches C1 to C3 are disengaged. As shown in FIGS. 1 and 3, the second sun gear S2 is thus held stationary by the first brake B1, whereby input rotation applied from the input shaft 12 to the second carrier CR2 is increased in speed and is output to the second ring gear R2. Since the fourth clutch C4 is engaged, the rotation of the second ring gear R2 increased in speed is output to the fourth sun gear S4. Since the fourth ring gear R4 is held stationary by the second brake B2, the rotation applied to the fourth sun gear S4 is reduced in speed and is output from the fourth carrier CR4 to the first ring gear R1. Since the first sun gear S1 is held stationary by the first brake B1, the rotation of the first ring gear R1 is further reduced in speed and is output from the first carrier CR1. The output shaft 13 thus rotates so that the gear ratio becomes equal to 4.677 as the first forward speed.

At the second forward speed (2nd), the third clutch C3 and the first and second brakes B1, B2 are engaged, and the first, second, and fourth clutches C1, C2, C4 are disengaged. The second sun gear S2 is thus held stationary by the first brake B1, whereby input rotation applied from the input shaft 12 to the second carrier CR2 is increased in speed and is output to the second ring gear R2. Since the third clutch C3 is engaged, the rotation of the second ring gear R2 increased in speed is output to the third carrier CR3. The input rotation from the input shaft 12 is also applied to the third ring gear R3 via the third coupling element 33 similarly to the second carrier CR2. Accordingly, the third sun gear S3 is increased in speed, and this rotation is output to the fourth sun gear S4 via the fourth coupling element 34. Since the fourth ring gear R4 is held stationary by the second brake B2, the rotation of the fourth sun gear S4 increased in speed is reduced in speed and is output from the fourth carrier CR4 to the first ring gear R1. Since the first sun gear S1 is held stationary by the first brake B1, the rotation of the first ring gear R1 reduced in speed is further reduced in speed and is output from the first carrier CR1. The first carrier CR1 thus rotates at a rotational speed higher than that at the first forward speed. Accordingly, the output shaft 13 rotates so that the gear ratio becomes equal to 3.026 as the second forward speed.

At the third forward speed (3rd), the third and fourth clutches C3, C4 and the second brake B2 are engaged, and the first and second clutches C1, C2 and the first brake B1 are disengaged. Since the third and fourth clutches C3, C4 are engaged, the second and third planetary gear mechanisms PM2, PM3 are in a directly coupled state, and rotation applied to the second carrier CR2 is output as it is to the fourth sun gear S4. Since the fourth ring gear R4 is held stationary by the second brake B2, the rotation of the fourth ring gear R4 is reduced in speed from the fourth carrier CR4 and is applied to the first ring gear R1. Since the input rotation from the input shaft 12 is applied as it is from the second sun gear S2 to the first sun gear S1 via the first coupling element 31, and the first carrier CR1 reduces the speed of this input rotation and rotates at a rotational speed slightly higher than that at the second forward speed. The output shaft 13 thus rotates so that the gear ratio becomes equal to 2.231 as the third forward speed.

At the fourth forward speed (4th), the first and third clutches C1, C3 and the second brake B2 are engaged, and the second and fourth clutches C2, C4 and the first brake B1 are disengaged. The fourth ring gear R4 is thus held stationary by the second brake B2. Moreover, the first clutch C1 is engaged, and the fourth carrier CR4 is coupled to the fourth sun gear S4. The entire fourth planetary gear mechanism PM4 is thus held stationary. Since the fourth carrier CR4 is coupled to the first ring gear R1 via the second coupling element 32 and the fourth sun gear S4 is coupled to the third sun gear S3 via the fourth coupling element 34, the first ring gear R1 and the third sun gear S3 are thus held stationary. As described above, since the third sun gear S3 is held stationary, and input rotation from the input shaft 12 is applied to the third ring gear R3, rotation of the third carrier CR3 is determined. Moreover, since the third carrier CR3 is coupled to the second ring gear R2 via the third clutch C3, rotation of the second ring gear R2 is also determined. Since the second ring gear R2 rotates at a rotational speed lower than that of the second carrier CR2 that receives the input rotation. Accordingly, rotation from the second carrier CR2 is increased in speed and is output to the second sun gear S2. This rotation of the second carrier CR2 increased in speed is applied to the first sun gear S1 via the first coupling element 31. Moreover, since the first ring gear R1 is held stationary, this rotation of the second carrier CR2 increased in speed is reduced in speed and is output to the first carrier CR1. The first carrier CR1 thus rotates at a rotational speed slightly higher than that at the third forward speed. The output shaft 13 thus rotates so that the gear ratio becomes equal to 1.877 as the fourth forward speed.

At the fifth forward speed (5th), the first and second clutches C1, C2 and the second brake B2 are engaged, and the third and fourth clutches C3, C4 and the first brake B1 are disengaged. Since the second brake B2 and the first clutch C1 are engaged, the first ring gear R1 and the third sun gear S3 are held stationary as in the case of the fourth forward speed. Since input rotation from the input shaft 12 is applied to the third ring gear R3 via the second carrier CR2 and the third coupling element 33, this input rotation is reduced in speed and is output from the third carrier CR3. Since the second clutch C2 is engaged, the third carrier CR3 is coupled to the first carrier CR1, and the rotation reduced in speed and output from the third carrier CR3 is output as it is from the first carrier CR1. Accordingly, the first carrier CR1 rotates at a rotational speed slightly higher than that at the fourth forward speed. The output shaft 13 thus rotates so that the gear ratio becomes equal to 1.650 as the fifth forward speed.

At the sixth forward speed (6th), the second and fourth clutches C2, C4 and the second brake B2 are engaged, and the first and third clutches C1, C3 and the first brake B1 are disengaged. Since the fourth ring gear R4 is held stationary by the second brake B2, the rotational speed of the fourth sun gear S4 is determined so as to be higher than that of the fourth carrier CR4. The fourth sun gear S4 is coupled to the third sun gear S3 by the fourth coupling element 34, and is also coupled to the second ring gear R2 via the fourth clutch C4. The third sun gear S3 and the second ring gear R2 thus make the same rotation as the fourth sun gear S4. The second sun gear S2 and the first sun gear S1 are coupled via the first coupling element 31 and make the same rotation, and the fourth carrier CR4 and the first ring gear R1 are coupled via the second coupling element 32 and make the same rotation. Moreover, the third carrier CR3 and the first carrier CR1 make the same rotation by the second clutch C2, and input rotation applied to the second carrier CR2 and the third ring gear R3 is reduced in speed by the first to fourth planetary gear mechanisms PM1 to PM4, and is output from the first carrier CR1 that rotates at a rotational speed slightly higher than that at the fifth forward speed. The output shaft 13 thus rotates so that the gear ratio becomes equal to 1.360 as the sixth forward speed.

At the seventh forward speed (7th), the first, second, and fourth clutches C1, C2, C4 are engaged, and the third clutch C3 and the first and second brakes B1, B2 are disengaged. All the rotary elements of the first to fourth planetary gear mechanisms PM1 to PM4 thus make the same rotation and the first to fourth planetary gear mechanisms PM1 to PM4 are in a directly coupled state, and input rotation of the input shaft 12 applied to the second carrier CR2 and the third ring gear R3 is output as it is from the first carrier CR1. The output shaft 13 thus rotates so that the gear ratio becomes equal to 1.000 as the seventh forward speed.

At the eighth forward speed (8th), the first and fourth clutches C1, C4 and the first brake B1 are engaged, and the second and third clutches C2, C3 and the second brake B2 are disengaged. Since the second sun gear S2 is held stationary by the first brake B1, input rotation of the input shaft 12 applied from the second carrier CR2 is increased in speed and is output from the second ring gear R2. Since the fourth clutch C4 is engaged, this rotation of the second ring gear R2 is transmitted to the fourth coupling element 34, and is output to the first ring gear R1 via the fourth planetary gear mechanism PM4 that is in a directly coupled state as the first clutch C1 is engaged. Since the first sun gear S1 is held stationary by the first brake B1, the rotation of the first ring gear R1 increased in speed is reduced in speed and is output from the first carrier CR1. The rotation of the first carrier CR1 thus has a higher speed than the input rotation from the input shaft 12, and the output shaft 13 rotates so that the gear ratio becomes equal to 0.935 as the eighth forward speed.

At the ninth forward speed (9th), the second and fourth clutches C2, C4 and the first brake B1 are engaged, and the first and third clutches C1, C3 and the second brake B2 are disengaged. Since the second sun gear S2 is held stationary by the first brake B1, input rotation of the input shaft 12 applied to the second carrier CR2 is increased in speed and is output from the second ring gear R2. Since the fourth clutch C4 is engaged, the rotation from the second ring gear R2 increased in speed is applied to the third sun gear S3. Since the input rotation is also applied to the third ring gear R3 similarly to the second carrier CR2, in the third carrier CR3, the input rotation from the third ring gear R3 is increased in speed and is output from the third carrier CR3. The third carrier CR3 is coupled to the first carrier CR1 by the clutch C2, and the first carrier CR1 rotates together with the third carrier CR3 at a rotational speed higher than that at the eighth forward speed. The output shaft 13 thus rotates so that the gear ratio becomes equal to 0.822 as the ninth forward speed.

At the tenth forward speed (10th), the first and second clutches C1, C2 and the first brake B1 are engaged, and the third and fourth clutches C3, C4 and the second brake B2 are disengaged. Since the first clutch C1 is engaged, the fourth planetary gear mechanism PM4 is in a directly coupled state. Since the first sun gear S1 is held stationary by the first brake B1, the first carrier CR1 rotates at a rotational speed reduced with respect to the first ring gear R1. Since the second clutch C2 is engaged, the first carrier CR1 is coupled to the third carrier CR3. Accordingly, when input rotation from the input shaft 12 is applied to the third ring gear R3 via the second carrier CR2 and the third coupling element 33, the third sun gear S3 and the first ring gear R1 make the same rotation and rotate at a rotational speed higher than that of the third and first carriers CR3, CR1, and the third and first carriers CR3, CR1 rotate at a rotational speed higher than that at the ninth forward speed. The output shaft 13 thus rotates so that the gear ratio becomes equal to 0.707 as the tenth forward speed.

At the eleventh forward speed (11th), the second and third clutches C2, C3 and the first brake B1 are engaged, and the first and fourth clutches C1, C4 and the second brake B2 are disengaged. Since the second sun gear S2 is held stationary by the first brake B1, input rotation of the input shaft 12 applied to the second carrier CR2 is increased in speed and is output to the second ring gear R2. Since the third clutch C3 and the second clutch C2 are engaged, the second ring gear R2 is coupled to the first carrier CR1 via the third carrier CR3, and the rotation of the second ring gear R2 increased in speed is output as it is to the first carrier CR1. The first carrier CR1 thus rotates at a rotational speed higher than that at the tenth forward speed, and the output shaft 13 rotates so that the gear ratio becomes equal to 0.645 as the eleventh forward speed.

At the twelfth forward speed (12th), the third and third clutches C1, C3 and the first brake B1 are engaged, and the second and fourth clutches C2, C4 and the second brake B2 are disengaged. Since the second sun gear S2 is held stationary by the first brake B1, input rotation of the input shaft 12 applied to the second carrier CR2 is increased in speed and is output to the second ring gear R2. The input rotation of the input shaft 12 is applied to the third ring gear R3, and the rotation of the second ring gear R2 increased in speed is applied to the third carrier CR3 as the third clutch C3 is engaged. Accordingly, the third sun gear S3 rotates at a rotational speed further increased with respect to the third carrier CR3. Since the first clutch C1 is engaged, the fourth planetary gear mechanism PM4 is in a directly coupled state, and the rotation of the third sun gear S3 increased in speed is applied as it is to the first ring gear R1. Since the first sun gear S1 is held stationary by the first brake B1, the rotation increased in speed and applied to the first ring gear R1 is reduced in speed and is output to the first carrier CR1. The first carrier CR1 thus rotates at a rotational speed higher than that at the eleventh forward speed, and the output shaft 13 rotates so that the gear ratio becomes equal to 0.605 as the twelfth forward speed.

At the reverse speed (Rev), the second clutch C2 and the first and second brakes B1, B2 are engaged, and the first, third, and fourth clutches C1, C2, C4 are disengaged. Input rotation of the input shaft 12 is thus applied to the third ring gear R3 via the second carrier CR2 and the third coupling element 33. Since the second clutch C2 is engaged, the third carrier CR3 is coupled to the first carrier CR1, and the third sun gear S3 is reversed and increased in speed significantly. This rotation of the third sun gear S3 thus reversed and increased in speed is applied to the fourth sun gear S4 via the fourth coupling element 34. Since the fourth ring gear R4 is held stationary by the second brake B2, the reversed rotation of the fourth sun gear S4 is reduced in speed and is applied from the fourth carrier CR4 to the first ring gear R1. Since the first sun gear S1 is held stationary by the first brake B1, the reversed rotation thus applied to the first ring gear R1 is further reduced in speed and is output from the first carrier CR1. The output shaft 13 thus rotates so that the gear ratio becomes equal to −3.063 as the reverse speed.

Configuring the automatic transmission 1 in this manner allows twelve forward speeds and one reverse speed to be attained by using the four planetary gear mechanisms PM1 to PM4, the four clutches C1 to C4, and the two brakes B1, B2. The gear spread from the lowest shift speed to the highest shift speed is thus as wide as 7.731 in the present embodiment, which can improve acceleration performance and fuel economy performance of vehicles. The step ratios between shift speeds for forward traveling do not vary so much and are relatively satisfactory, and smooth shifting to an optimal shift speed can be implemented.

Moreover, each shift speed is attained by engaging three of the six engagement elements and disengaging the remaining three engagement elements. Accordingly, the number of engagement elements to be disengaged to attain a shift speed is relatively small, which can reduce drag loss that is caused by the disengaged engagement elements, and can improve transmission efficiency of the automatic transmission. In particular, the second and third clutches C2, C3 have larger torque capacity (torque sharing ratio) and a larger number of friction plates than the other engagement elements C1, C4, B1, B2, and therefore have greater drag loss. However, since the second and third clutches C2, C3 are engaged at the shift speeds (in the present embodiment, the ninth to eleventh forward speeds for the second clutch C2, and the eleventh to twelfth forward speeds for the third clutch C3) equal to or higher than the direct coupling shift speed (in the present embodiment, the seventh forward speed) that is frequently used when, e.g., the vehicle travels for a long distance such as when the vehicle travels on an expressway, the transmission efficiency of the automatic transmission can further be improved. Moreover, since the fourth or fourth clutch C1, C4 and the first or second brake B1, B2 can have small torque capacity, the number of friction plates in these friction engagement elements can be reduced, and the overall length and cost of the automatic transmission can be reduced.

In the above automatic transmission, all of the four planetary gear mechanisms PM1 to PM4 are single-pinion type planetary gear mechanisms. This can reduce gear meshing loss and can thus improve the transmission efficiency of the automatic transmission. This can also reduce the number of components and can thus reduce assembly time and cost of the automatic transmission. In particular, in the present embodiment, gear efficiency of 95% or more can be achieved at every forward speed, and the rotational speeds of the pinion gears can be made relatively low.

### Second Embodiment

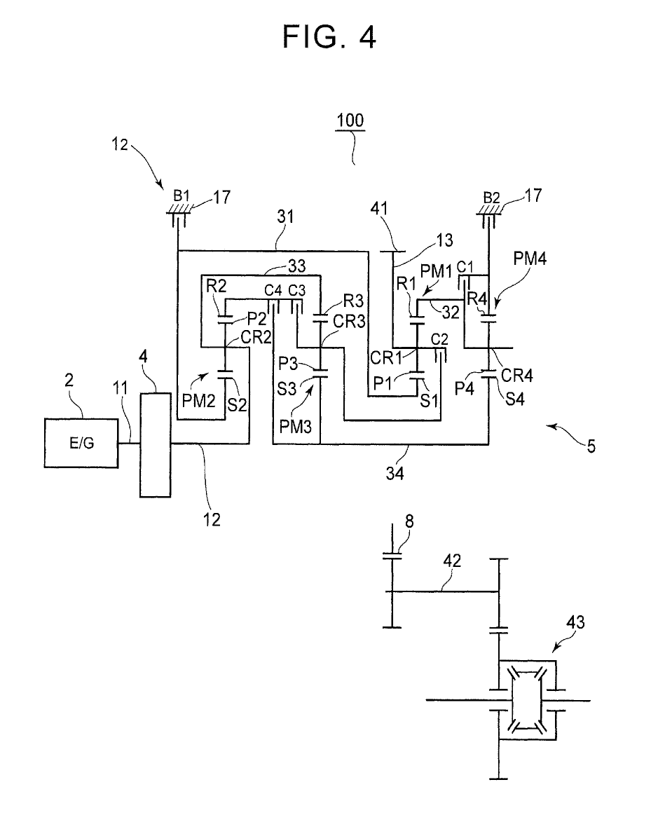

A second embodiment that is obtained by partially changing the first embodiment will be described below with reference to FIG. 4. Only the portions changed from the first embodiment will be described in the second embodiment. The other portions are denoted with the same reference characters as those in the first embodiment, and description thereof will be omitted.

As shown in FIG. 4, an automatic transmission 1₂ according to the second embodiment is different from the automatic transmission 1₁ according to the first embodiment in the placement (coupling relation) of the first clutch C1. That is, the first clutch C1 in the second embodiment can engage the fourth carrier CR4 with the fourth ring gear R4 and can disengage the fourth carrier CR4 from the fourth ring gear R4. Accordingly, by engaging the first clutch C1, the fourth carrier CR4 is coupled to the fourth ring gear R4, so that the fourth carrier CR4 and the fourth ring gear R4 of the fourth planetary gear mechanism PM4 make the same rotation, and the fourth planetary gear mechanism PM4 is thus brought into an integrally rotating state, namely in the state where the fourth sun gear S4, the fourth carrier CR4, and the fourth ring gear R4 rotate together. The fourth carrier CR4 is decoupled from the fourth ring gear R4 (the fourth planetary gear mechanism PM4 is caused to be no longer in the integrally rotating state) by disengaging the first clutch C1.

The placement (coupling relation) of the first clutch C1 is changed in the second embodiment. However, the clutch C1 has a function similar to that in the first embodiment, namely a function to bring the fourth planetary gear mechanism PM4 into the integrally rotating state when engaged and to cause the fourth planetary gear mechanism PM4 to be no longer in the integrally rotating state when disengaged. Since the configuration, functions, and effects of the second embodiment are otherwise similar to those of the first embodiment, description thereof will be omitted.

### Third Embodiment

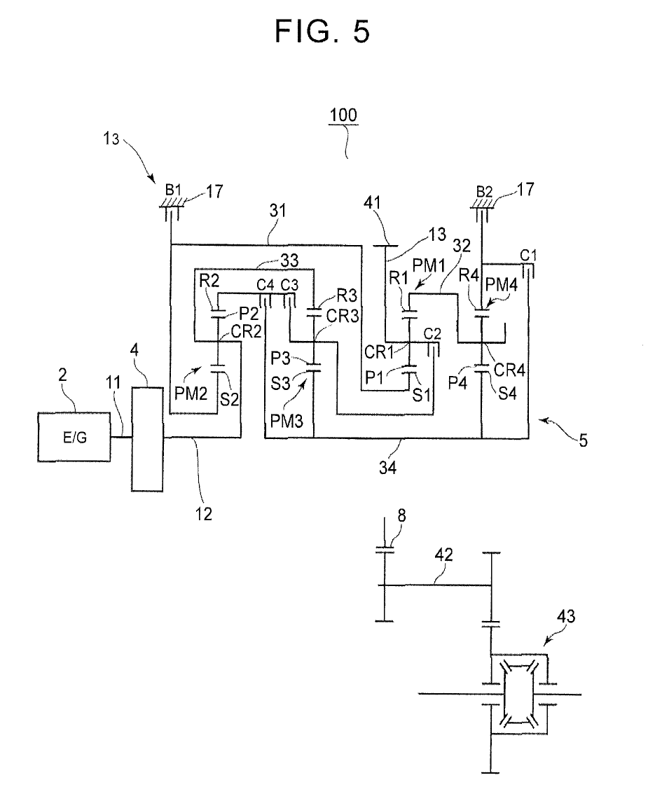

A third embodiment that is obtained by partially changing the first and second embodiments will be described below with reference to FIG. 5. Only the portions changed from the first and second embodiments will be described in the third embodiment. The other portions are denoted with the same reference characters as those in the first and second embodiments, and description thereof will be omitted.

As shown in FIG. 5, an automatic transmission 1₃ according to the third embodiment is different from the automatic transmissions 1₁, 1₂ according to the first and second embodiments in the placement (coupling relation) of the first clutch C1. That is, the first clutch C1 in the third embodiment can engage the fourth sun gear S4 with the fourth ring gear R4 and can disengage the fourth sun gear S4 from the fourth ring gear R4. Accordingly, by engaging the first clutch C1, the fourth sun gear S4 is coupled to the fourth ring gear R4, so that the fourth sun gear S4 and the fourth ring gear R4 of the fourth planetary gear mechanism PM4 make the same rotation, and the fourth planetary gear mechanism PM4 is thus brought into an integrally rotating state, namely in the state where the fourth sun gear S4, the fourth carrier CR4, and the fourth ring gear R4 rotate together. The fourth sun gear S4 is decoupled from the fourth ring gear R4 (the fourth planetary gear mechanism PM4 is caused to be no longer in the integrally rotating state) by disengaging the first clutch C1.

The placement (coupling relation) of the first clutch C1 is changed in the third embodiment. However, the clutch C1 has a function similar to that in the first and second embodiments, namely a function to bring the fourth planetary gear mechanism PM4 into the integrally rotating state when engaged and to cause the fourth planetary gear mechanism PM4 to be no longer in the integrally rotating state when disengaged. Since the configuration, functions, and effects of the third embodiment are otherwise similar to those of the first and second embodiments, description thereof will be omitted.

In the above embodiments, an internal combustion engine is used as a drive source. However, an electric motor etc. may be used, or a combination of the internal combustion engine and the electric motor may be used as a drive source. Although the automatic transmissions according to the above embodiments can attain at least twelve forward speeds and one reverse speed, it is not necessary to use all the shift speeds.

### INDUSTRIAL APPLICABILITY

The automatic transmission according to the present disclosure can be used for vehicles such as passenger cars and trucks, and is preferably used particularly for vehicles that have a wide gear spread and that are desired to have improved transmission efficiency.

1. An automatic transmission that shifts power applied to an input member and outputs the shifted power to an output member, the automatic transmission comprising:
a first planetary gear mechanism having a first rotary element, a second rotary element, and a third rotary element in order of an interval corresponding to a gear ratio in a speed diagram;
a second planetary gear mechanism having a fourth rotary element, a fifth rotary element, and a sixth rotary element in order of an interval corresponding to a gear ratio in a speed diagram;
a third planetary gear mechanism having a seventh rotary element, an eighth rotary element, and a ninth rotary element in order of an interval corresponding to a gear ratio in a speed diagram;
a fourth planetary gear mechanism having a tenth rotary element, an eleventh rotary element, and a twelfth rotary element in order of an interval corresponding to a gear ratio in a speed diagram;
a first coupling element that couples the first rotary element to the fourth rotary element;
a second coupling element that couples the third rotary element to the eleventh rotary element;
a third coupling element that couples the fifth rotary element to the ninth rotary element;
a fourth coupling element that couples the seventh rotary element to the tenth rotary element;
a first clutch capable of engaging two of the tenth rotary element, the eleventh rotary element, and the twelfth rotary element with each other and disengaging the two of the tenth rotary element, the eleventh rotary element, and the twelfth rotary element from each other;
a second clutch capable of engaging the second rotary element with the eighth rotary element and disengaging the second rotary element from the eighth rotary element;
a third clutch capable of engaging the sixth rotary element with the eighth rotary element and disengaging the sixth rotary element from the eighth rotary element;
a fourth clutch capable of engaging the sixth rotary element with the fourth coupling element and disengaging the sixth rotary element from the fourth coupling element;
a first brake that engages the first coupling element with an automatic transmission case so that the first coupling element can be held stationary with respect to the automatic transmission case, and that disengages the first coupling element from the automatic transmission case; and
a second brake that engages the twelfth rotary element with the automatic transmission case so that the twelfth rotary element can be held stationary with respect to the automatic transmission case, and that disengages the twelfth rotary element from the automatic transmission case, wherein
the input member is coupled to the fifth rotary element, and
the output member is coupled to the second rotary element.

2. The automatic transmission according to claim 1, wherein
the first clutch can engage the tenth rotary element with the eleventh rotary element and can disengage the tenth rotary element from the eleventh rotary element.

3. The automatic transmission according to claim 1, wherein
the first clutch can engage the eleventh rotary element with the twelfth rotary element and can disengage the eleventh rotary element from the twelfth rotary element.

4. The automatic transmission according to claim 1, wherein
the first clutch can engage the tenth rotary element with the twelfth rotary element and can disengage the tenth rotary element from the twelfth rotary element.

5. The automatic transmission according to claim 1, wherein
the first rotary element is a first sun gear,
the second rotary element is a first carrier,
the third rotary element is a first ring gear,
the fourth rotary element is a second sun gear,
the fifth rotary element is a second carrier,
the sixth rotary element is a second ring gear,
the seventh rotary element is a third sun gear,
the eighth rotary element is a third carrier,
the ninth rotary element is a third ring gear,
the tenth rotary element is a fourth sun gear,
the eleventh rotary element is a fourth carrier, and
the twelfth rotary element is a fourth ring gear.

6. The automatic transmission according to claim 1, wherein
a first forward speed is attained by engaging the fourth clutch, the first brake, and the second brake and disengaging the first clutch, the second clutch, and the third clutch,
a second forward speed is attained by engaging the third clutch, the first brake, and the second brake and disengaging the first clutch, the second clutch, and the fourth clutch,
a third forward speed is attained by engaging the third clutch, the fourth clutch, and the second brake and disengaging the first clutch, the second clutch, and the first brake,
a fourth forward speed is attained by engaging the first clutch, the third clutch, and the second brake and disengaging the second clutch, the fourth clutch, and the first brake,
a fifth forward speed is attained by engaging the first clutch, the second clutch, and the second brake and disengaging the third clutch, the fourth clutch, and the first brake,
a sixth forward speed is attained by engaging the second clutch, the fourth clutch, and the second brake and disengaging the first clutch, the third clutch, and the first brake,
a seventh forward speed is attained by engaging the first clutch, the second clutch, and the fourth clutch and disengaging the third clutch, the first brake, and the second brake,
an eighth forward speed is attained by engaging the first clutch, the fourth clutch, and the first brake and disengaging the second clutch, the third clutch, and the second brake,
a ninth forward speed is attained by engaging the second clutch, the fourth clutch, and the first brake and disengaging the first clutch, the third clutch, and the second brake,
a tenth forward speed is attained by engaging the first clutch, the second clutch, and the first brake and disengaging the third clutch, the fourth clutch, and the second brake,
an eleventh forward speed is attained by engaging the second clutch, the third clutch, and the first brake and disengaging the first clutch, the fourth clutch, and the second brake,
a twelfth forward speed is attained by engaging the first clutch, the third clutch, and the first brake and disengaging the second clutch, the fourth clutch, and the second brake, and
a reverse speed is attained by engaging the second clutch, the first brake, and the second brake and disengaging the first clutch, the third clutch, and the fourth clutch.

7. The automatic transmission according to claim 2, wherein
the first rotary element is a first sun gear,
the second rotary element is a first carrier,
the third rotary element is a first ring gear,
the fourth rotary element is a second sun gear,
the fifth rotary element is a second carrier,
the sixth rotary element is a second ring gear,
the seventh rotary element is a third sun gear,
the eighth rotary element is a third carrier,
the ninth rotary element is a third ring gear,
the tenth rotary element is a fourth sun gear,
the eleventh rotary element is a fourth carrier, and
the twelfth rotary element is a fourth ring gear.

8. The automatic transmission according to claim 3, wherein
the first rotary element is a first sun gear,
the second rotary element is a first carrier,
the third rotary element is a first ring gear,
the fourth rotary element is a second sun gear,
the fifth rotary element is a second carrier,
the sixth rotary element is a second ring gear,
the seventh rotary element is a third sun gear,
the eighth rotary element is a third carrier,
the ninth rotary element is a third ring gear,
the tenth rotary element is a fourth sun gear,
the eleventh rotary element is a fourth carrier, and
the twelfth rotary element is a fourth ring gear.

9. The automatic transmission according to claim 4, wherein
the first rotary element is a first sun gear,
the second rotary element is a first carrier,
the third rotary element is a first ring gear,
the fourth rotary element is a second sun gear,
the fifth rotary element is a second carrier,
the sixth rotary element is a second ring gear,
the seventh rotary element is a third sun gear,
the eighth rotary element is a third carrier,
the ninth rotary element is a third ring gear,
the tenth rotary element is a fourth sun gear,
the eleventh rotary element is a fourth carrier, and
the twelfth rotary element is a fourth ring gear.

10. The automatic transmission according to claim 7, wherein
a first forward speed is attained by engaging the fourth clutch, the first brake, and the second brake and disengaging the first clutch, the second clutch, and the third clutch,
a second forward speed is attained by engaging the third clutch, the first brake, and the second brake and disengaging the first clutch, the second clutch, and the fourth clutch,
a third forward speed is attained by engaging the third clutch, the fourth clutch, and the second brake and disengaging the first clutch, the second clutch, and the first brake,
a fourth forward speed is attained by engaging the first clutch, the third clutch, and the second brake and disengaging the second clutch, the fourth clutch, and the first brake,
a fifth forward speed is attained by engaging the first clutch, the second clutch, and the second brake and disengaging the third clutch, the fourth clutch, and the first brake,
a sixth forward speed is attained by engaging the second clutch, the fourth clutch, and the second brake and disengaging the first clutch, the third clutch, and the first brake,
a seventh forward speed is attained by engaging the first clutch, the second clutch, and the fourth clutch and disengaging the third clutch, the first brake, and the second brake,
an eighth forward speed is attained by engaging the first clutch, the fourth clutch, and the first brake and disengaging the second clutch, the third clutch, and the second brake,
a ninth forward speed is attained by engaging the second clutch, the fourth clutch, and the first brake and disengaging the first clutch, the third clutch, and the second brake,
a tenth forward speed is attained by engaging the first clutch, the second clutch, and the first brake and disengaging the third clutch, the fourth clutch, and the second brake,
an eleventh forward speed is attained by engaging the second clutch, the third clutch, and the first brake and disengaging the first clutch, the fourth clutch, and the second brake,
a twelfth forward speed is attained by engaging the first clutch, the third clutch, and the first brake and disengaging the second clutch, the fourth clutch, and the second brake, and
a reverse speed is attained by engaging the second clutch, the first brake, and the second brake and disengaging the first clutch, the third clutch, and the fourth clutch.

11. The automatic transmission according to claim 8, wherein
a first forward speed is attained by engaging the fourth clutch, the first brake, and the second brake and disengaging the first clutch, the second clutch, and the third clutch,
a second forward speed is attained by engaging the third clutch, the first brake, and the second brake and disengaging the first clutch, the second clutch, and the fourth clutch,
a third forward speed is attained by engaging the third clutch, the fourth clutch, and the second brake and disengaging the first clutch, the second clutch, and the first brake,
a fourth forward speed is attained by engaging the first clutch, the third clutch, and the second brake and disengaging the second clutch, the fourth clutch, and the first brake,
a fifth forward speed is attained by engaging the first clutch, the second clutch, and the second brake and disengaging the third clutch, the fourth clutch, and the first brake,
a sixth forward speed is attained by engaging the second clutch, the fourth clutch, and the second brake and disengaging the first clutch, the third clutch, and the first brake,
a seventh forward speed is attained by engaging the first clutch, the second clutch, and the fourth clutch and disengaging the third clutch, the first brake, and the second brake,
an eighth forward speed is attained by engaging the first clutch, the fourth clutch, and the first brake and disengaging the second clutch, the third clutch, and the second brake,
a ninth forward speed is attained by engaging the second clutch, the fourth clutch, and the first brake and disengaging the first clutch, the third clutch, and the second brake,
a tenth forward speed is attained by engaging the first clutch, the second clutch, and the first brake and disengaging the third clutch, the fourth clutch, and the second brake,
an eleventh forward speed is attained by engaging the second clutch, the third clutch, and the first brake and disengaging the first clutch, the fourth clutch, and the second brake,
a twelfth forward speed is attained by engaging the first clutch, the third clutch, and the first brake and disengaging the second clutch, the fourth clutch, and the second brake, and
a reverse speed is attained by engaging the second clutch, the first brake, and the second brake and disengaging the first clutch, the third clutch, and the fourth clutch.

12. The automatic transmission according to claim 9, wherein
a first forward speed is attained by engaging the fourth clutch, the first brake, and the second brake and disengaging the first clutch, the second clutch, and the third clutch,
a second forward speed is attained by engaging the third clutch, the first brake, and the second brake and disengaging the first clutch, the second clutch, and the fourth clutch,
a third forward speed is attained by engaging the third clutch, the fourth clutch, and the second brake and disengaging the first clutch, the second clutch, and the first brake,
a fourth forward speed is attained by engaging the first clutch, the third clutch, and the second brake and disengaging the second clutch, the fourth clutch, and the first brake,
a fifth forward speed is attained by engaging the first clutch, the second clutch, and the second brake and disengaging the third clutch, the fourth clutch, and the first brake,
a sixth forward speed is attained by engaging the second clutch, the fourth clutch, and the second brake and disengaging the first clutch, the third clutch, and the first brake,
a seventh forward speed is attained by engaging the first clutch, the second clutch, and the fourth clutch and disengaging the third clutch, the first brake, and the second brake,
an eighth forward speed is attained by engaging the first clutch, the fourth clutch, and the first brake and disengaging the second clutch, the third clutch, and the second brake,
a ninth forward speed is attained by engaging the second clutch, the fourth clutch, and the first brake and disengaging the first clutch, the third clutch, and the second brake,
a tenth forward speed is attained by engaging the first clutch, the second clutch, and the first brake and disengaging the third clutch, the fourth clutch, and the second brake,
an eleventh forward speed is attained by engaging the second clutch, the third clutch, and the first brake and disengaging the first clutch, the fourth clutch, and the second brake,
a twelfth forward speed is attained by engaging the first clutch, the third clutch, and the first brake and disengaging the second clutch, the fourth clutch, and the second brake, and
a reverse speed is attained by engaging the second clutch, the first brake, and the second brake and disengaging the first clutch, the third clutch, and the fourth clutch.

13. The automatic transmission according to claim 5, wherein
a first forward speed is attained by engaging the fourth clutch, the first brake, and the second brake and disengaging the first clutch, the second clutch, and the third clutch,
a second forward speed is attained by engaging the third clutch, the first brake, and the second brake and disengaging the first clutch, the second clutch, and the fourth clutch,
a third forward speed is attained by engaging the third clutch, the fourth clutch, and the second brake and disengaging the first clutch, the second clutch, and the first brake,
a fourth forward speed is attained by engaging the first clutch, the third clutch, and the second brake and disengaging the second clutch, the fourth clutch, and the first brake,
a fifth forward speed is attained by engaging the first clutch, the second clutch, and the second brake and disengaging the third clutch, the fourth clutch, and the first brake,
a sixth forward speed is attained by engaging the second clutch, the fourth clutch, and the second brake and disengaging the first clutch, the third clutch, and the first brake,
a seventh forward speed is attained by engaging the first clutch, the second clutch, and the fourth clutch and disengaging the third clutch, the first brake, and the second brake,
an eighth forward speed is attained by engaging the first clutch, the fourth clutch, and the first brake and disengaging the second clutch, the third clutch, and the second brake,
a ninth forward speed is attained by engaging the second clutch, the fourth clutch, and the first brake and disengaging the first clutch, the third clutch, and the second brake,
a tenth forward speed is attained by engaging the first clutch, the second clutch, and the first brake and disengaging the third clutch, the fourth clutch, and the second brake,
an eleventh forward speed is attained by engaging the second clutch, the third clutch, and the first brake and disengaging the first clutch, the fourth clutch, and the second brake,
a twelfth forward speed is attained by engaging the first clutch, the third clutch, and the first brake and disengaging the second clutch, the fourth clutch, and the second brake, and
a reverse speed is attained by engaging the second clutch, the first brake, and the second brake and disengaging the first clutch, the third clutch, and the fourth clutch.
